(19) United States
(12) Patent Application Publication
(10) Pub. No.: US 2024/0227851 A9
(43) Pub. Date: Jul. 11, 2024

(54) METHOD FOR ASSISTIVE OR AUTOMATED VEHICLE CONTROL

(71) Applicant: Continental Autonomous Mobility Germany GmbH, Ingolstadt (DE)

(72) Inventors: Christopher Knievel, Eriskirch (DE); Lars Krüger, Ulm (DE)

(73) Assignee: Continental Autonomous Mobility Germany GmbH, Ingolstadt (DE)

(21) Appl. No.: 18/546,844

(22) PCT Filed: Dec. 9, 2021
(86) PCT No.: PCT/DE2021/200255

§ 371 Date: Aug. 17, 2023

(30) Foreign Application Priority Data
Feb. 17, 2021 (DE) 10 2021 201 521.2

(51) Int. Cl. B60W 60/00

(52) U.S. Cl. CPC B60W 60/001; B60W 2554/20; B60W 2554/4049; B60W 2554/80; B60W 2556/10

(57) ABSTRACT

The present disclosure relates to a method for the assistive or automated vehicle control of an ego-vehicle, the ego-vehicle including a control device and at least one sensor for environment and object detection, wherein, for the vehicle control of the ego-vehicle, trajectory planning is carried out on the basis of the detected environment and the detected objects, boids which are defined using rules of attraction and repulsion are generated for the objects, and the trajectory planning is carried out using the boids.

### CROSS-REFERENCE TO RELATED APPLICATIONS

The present application is a National Stage Application under 35 U.S.C. § 371 of International Patent Application No. PCT/DE2021/200255 filed on Dec. 9, 2021, and claims priority from German Patent Application No. 10 2021 201 521.2 filed on Feb. 17, 2021, in the German Patent and Trademark Office, the disclosures of which are herein incorporated by reference in their entireties.

### TECHNICAL FIELD

The present invention relates to a method, in particular a computer-implemented method, for the assistive or automated vehicle control of an ego-vehicle as well as a driver assistance system for an ego-vehicle for the assistive or automated vehicle control of the ego-vehicle.

### BACKGROUND

Generic vehicles such as, e.g., passenger cars, trucks or motorcycles, are increasingly being equipped with driver assistance systems which, with the aid of sensor systems, can detect the surroundings or the environment, recognize traffic situations and assist the driver, e.g., by a braking or steering intervention or by outputting a visual, haptic or acoustic warning. Radar sensors, lidar sensors, camera sensors, ultrasonic sensors or the like are regularly deployed as sensor systems for detecting the environment. Conclusions can subsequently be drawn about the surroundings from the sensor data established by the sensors, with which, e.g., a so-called environmental model can also be generated. Based thereon, instructions for warning/informing the driver or for regulated steering, braking and acceleration can subsequently be output. Assistance functions which process the sensor and environmental data can prevent accidents with other road users, for example, or can facilitate complicated driving maneuvers by assisting with, or even completely taking over (in a partially or fully automated manner), the driving task or the vehicle control. For example, the vehicle can adjust the speed and the manner in which the vehicle follows a car driving ahead, e.g., by means of an Emergency Brake Assist (EBA), Automatic Emergency Brake (AEB) or Adaptive Cruise Control (ACC).

Furthermore, the trajectory to be driven or the movement path of the vehicle can be determined. Static targets or objects can be detected on the basis of the sensor technology, as a result of which, e.g., the distance from a vehicle driving ahead or the course of the road can be estimated. The detection or recognition of objects and, in particular, the plausibility checking thereof are particularly important in order to recognize, for example, whether a vehicle driving ahead is relevant to the respective assistance function or regulation. One criterion in this case is that, e.g., an object recognized as a target vehicle (target) is driving in the same lane as the driver's own vehicle (ego-vehicle). Known driver assistance systems endeavor, e.g., with the aid of the sensor technology, to estimate the course of a lane in order to establish whether a target vehicle is located in the vehicle's own lane. Information about the lane markings, peripheral development and the path driven by other vehicles is utilized for this purpose. Furthermore, a suitable algorithm (e.g., curve-fitting algorithm) is applied in order to predict the future path or the trajectory of the ego-vehicle. Moreover, a deviation of the other road users from this path can be utilized in order to decide in which lane the respective road user is driving.

Known systems either do not utilize any reliability information or take ideal reliability information, e.g., the standard deviation of a measured variable. Admittedly, these error models are not sufficiently precise for sensors to utilize the reliability information, e.g., directly as a weighting factor. Two error sources are especially critical: an erroneous prediction of the course of the vehicle's own lane and an erroneous/unreliable measurement of the position of the observed road user or the other road users, which can lead to an excessive deviation from the predicted path.

Both error sources can only be corrected if the correct reliability information is known. This results in a high computational cost and poor scalability, both for multiple objects and for new object types. However, in driver assistance functions such as, in particular, ACC, relevant objects already have to be selected at great distances, for the most part. To this end, the object detection is carried out, as a general rule, via a radar sensor which has a sufficient sensor range and detection reliability. Nevertheless, the quality of the geometric or kinematic estimates at the start of the measurement is frequently still too poor, or too few measurements were carried out or too few measuring points were generated. The variations in the applied filters are frequently too great so that, e.g., it is not possible to sufficiently reliably assign lanes to radar objects, for example at a distance of 200 meters.

DE 10 2015 205 135 A1 discloses a method in which the relevant objects of a scene (e.g., guardrails, lane center lines, road users) are depicted as objects in a swarm: the objects are recognized by means of external sensor technology and depicted in object constellations, wherein an object constellation comprises two or more objects, i.e., measurements/objects are combined in order to save computing time and to increase the accuracy of the estimation. Accordingly, the combinations of different measurements of the same object do not, however, represent technically necessary constellations for achieving a saving in computing time, since they relate to different measurements of the same object and not different objects. The data from the external sensor technology can, for example, be raw sensor data or pre-processed sensor data and/or sensor data selected in accordance with predetermined criteria. For example, the data can be image data, laser scanner data or object lists, object contours or so-called point clouds (which represent, e.g., an arrangement of specific object parts or object edges).

### SUMMARY

Proceeding from the prior art, there is a need to make available a method which can increase the accuracy of the estimation with an advantageous computing time.

The aforementioned problem is addressed by the entire teaching of claim 1 and of the alternative, independent claim. Expedient configurations of the invention are claimed in the subclaims.

In the case of the method according to the present disclosure for the assistive or automated vehicle control of an ego-vehicle, the ego-vehicle includes a control device and at least one sensor, such as multiple sensors, for environment detection, wherein the sensors detect objects in the environment of the ego-vehicle. Furthermore, trajectory planning is carried out on the basis of the detected environment, wherein the vehicle control of the ego-vehicle is carried out on the basis of the trajectory planning, for which the objects in the environment are enlisted for trajectory planning. Boids which are defined using rules of attraction and repulsion are then generated for the objects. The trajectory planning is then carried out on the basis of the boids. This results in the advantage that the accuracy of the estimation can be increased and the required computing time can be particularly reduced.

The term “trajectory planning” within the meaning of the present disclosure also expressly includes, in addition to the planning in space and time (trajectory planning), purely spatial planning (path planning). Accordingly, the boids can also only be used in one part of the system, e.g., for adapting the speed or for selecting a specific object (“object-of-interest selection”).

The rules of attraction and repulsion are defined by defining objects which are arranged close to one another and parallel as attractive boids, and objects which are arranged parallel at a greater distance from one another as repelling boids.

Expediently, repelling boids may be defined for static objects and attractive boids may be defined for moving objects.

According to an advantageous configuration of the present disclosure, moving objects may be observed (tracked) over time so that a movement history is created, and attractive boids are defined using the movement history.

Furthermore, the detected objects and/or the boids may be saved in an object list in which all of the detected objects are saved with all the detected data (position, speed, signal strength, classification, elevation and the like).

A feature space may be expediently defined using the position and direction of movement of the ego-vehicle, wherein the rules of attraction for all boids may be converged on a point in the feature space. As a result, the measuring accuracy may still be additionally improved.

The feature space is defined using the clothoid parameters of the trajectory planning.

Advantageously, the feature space may also be extended to other road users. As a result, the measuring accuracy may be particularly increased: in addition, the environment recognition is particularly improved.

At least one camera and/or a lidar sensor and/or a radar sensor and/or an ultrasonic sensor and/or another sensor for environment detection known from the prior art may be expediently provided as the sensor for environment detection.

In addition, in an alternative, the present disclosure includes a driver assistance system for an ego-vehicle for the assistive or automated vehicle control of the ego-vehicle, the ego-vehicle including a control device and at least one sensor, such as multiple sensors, for environment detection, wherein the sensors detect objects in the environment of the ego-vehicle. The control device carries out trajectory planning on the basis of the detected environment, wherein the vehicle control of the ego-vehicle is carried out on the basis of the trajectory planning. The sensor for environment and object detection may be, e.g., a radar sensor, a lidar sensor, a camera sensor or ultrasonic sensor. The objects are enlisted for trajectory planning, wherein boids which are defined using rules of attraction and repulsion are generated for the objects so that the trajectory planning may then be carried out, taking account of the boids.

Furthermore, the driver assistance system may be a system which, in addition to a sensor for environment detection, includes a computer, processor, controller, data processor or the like in order to carry out the method according to the present disclosure. A computer program may be provided with program code for carrying out the method according to the present disclosure when the computer program is run on a computer or other programmable data processor known from the prior art. Accordingly, the method may also be run in existing systems as a computer-implemented method or may be retrofitted. The term “computer-implemented method” within the meaning of the present disclosure describes the process planning or procedure which is realized or carried out using the computer. The computer may process the data by means of programmable calculation specifications. With respect to the method, material properties may, consequently, also be implemented subsequently, e.g., by a new program, new programs, an algorithm or the like. The computer may be configured as a control device or as a part of the control device (e.g., as an IC (integrated circuit) component, microcontroller or system-on-chip (SoC)).

### BRIEF DESCRIPTION OF THE DRAWINGS

The invention is explained in greater detail below with reference to expedient exemplary embodiments, wherein:

FIG. 1 shows an extremely simplified schematic representation of an ego-vehicle having an assistance system according to the present disclosure;

FIG. 2 shows a simplified representation of a traffic scene, in which an ego-vehicle drives through a bend which has already been driven through by multiple other vehicles, and

FIG. 3 shows a simplified representation of the traffic scene from FIG. 2, in which the measuring principle according to the present disclosure is depicted on the basis of different measuring points.

### DETAILED DESCRIPTION

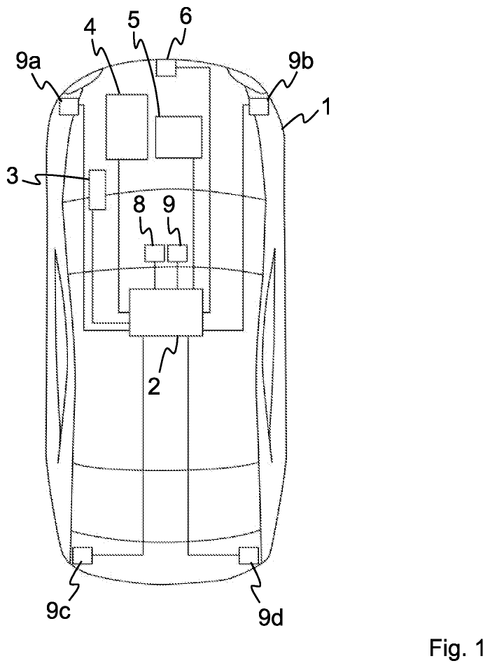

Reference numeral 1 in FIG. 1 denotes an ego-vehicle which has a control device 2 (ECU, Electronic Control Unit or ADCU, Assisted and Automated Driving Control Unit), different actuators (steering 3, engine 4, brake 5) as well as sensors for environment detection (camera 6, lidar sensor 7, radar sensor 8 as well as ultrasonic sensors 9a-9d). The ego-vehicle 1 may be controlled in a (partially) automated manner in that the control device 2 may access the actuators and the sensors or the sensor data thereof. In the field of assisted or (partially) automated driving, the sensor data may be utilized for environment and object recognition so that different assistance functions such as, e.g., Adaptive Cruise Control (ACC), Electronic Brake Assist (EBA), lane keeping control or a Lane Keep Assist (LKA), Park Assist or the like, may be realized via the control device 2 or the algorithm saved therein.

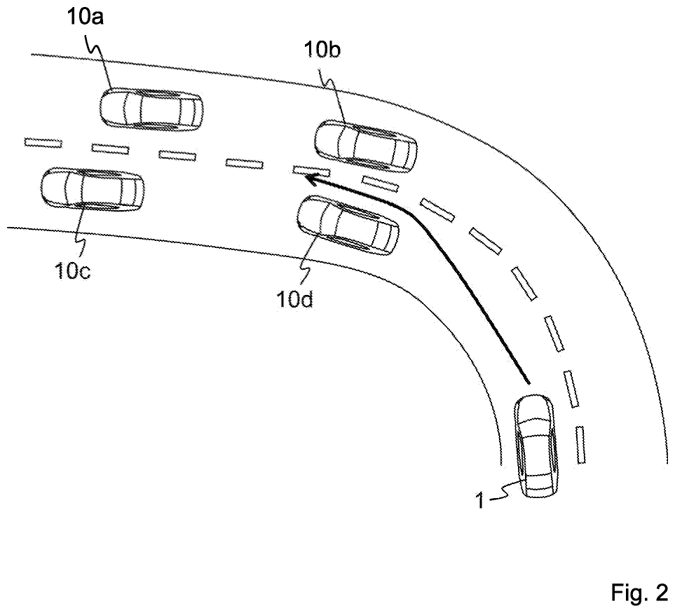

A typical traffic scene is depicted in FIG. 2, in which the ego-vehicle 1 is entering a bend which was previously driven through by multiple vehicles driving ahead 10a, 10b, 10c, 10d. The ego-vehicle 1 may, in this case, capture the surrounding objects (vehicles driving ahead 10a-10d, road markings, peripheral development and the like) using the sensors for environment detection and create its own path or the trajectory to be driven on the basis of the information. Furthermore, movements of other road users may be predicted and enlisted for trajectory planning. For example, the trajectory created (depicted using a black arrow) on the basis of the detection points and movement prediction of the vehicle 10d is, however, suboptimal or erroneous since said trajectory does not follow the course of the lane based on the movement prediction of vehicle 10d, but would rather result in an unwanted lane change in the area of the bend.

In the case of the method according to the present disclosure, the relevant objects of a scene (guardrails, lane center lines, road users and the like) are now depicted as objects in a swarm (i.e., as a kind of group or amalgamation of objects). In contrast to a known simple combination of objects (simple cluster), the detected objects are not only combined but rather are maintained as individuals and have an influence on one another, i.e., they interact with one another. The behavior of these objects is defined based on the sensor data and the relationships with one another, i.e., the interaction of objects similarly to so-called boids (interacting objects for simulating a swarm behavior), with simple rules. In this case, a boid corresponds to a measured object and not to a combined constellation of objects, i.e., the boids semantically represent individual objects and not simple constellations. In the case of boid-based models, the complexity of the model is the result of the interaction of the individual objects or boids which follow simple rules such as, e.g., separation (a choice of movement or direction which counteracts an accumulation of boids), alignment (a choice of movement or direction which corresponds to the mean direction of the neighboring boids) or cohesion (a choice of movement or direction which corresponds to the mean position of the neighboring boids).

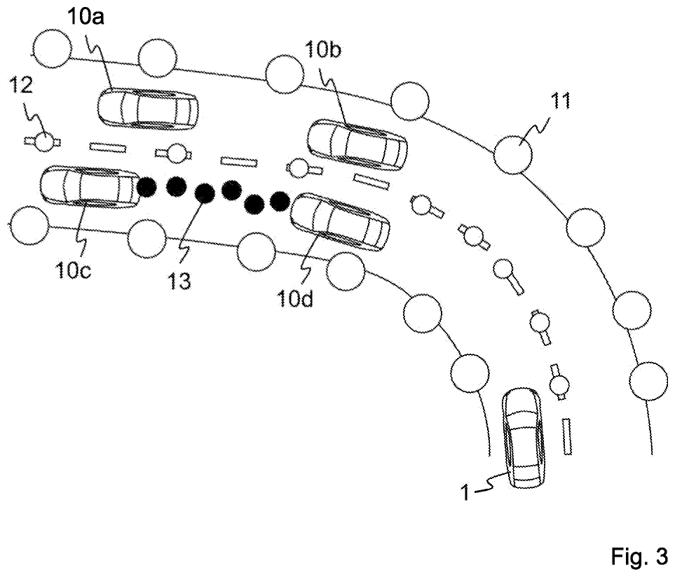

In FIG. 3, the measuring principle is depicted with boids 11, 12, 13 of road markings and vehicles or the driving paths thereof using the example of the road scene from FIG. 2. For example, a new measurement of a road marking (e.g., modeled as a straight line in sections) is added, in each cycle, to the existing list of road marking objects. The rules of attraction and repulsion are calculated thereafter (e.g., objects which are close and parallel attract one another; objects which are parallel but at a greater distance repel one another). Consequently, repelling boids 11 for the road edges and repelling boids 12 for the middle of the road may be generated (e.g., on the basis of road marking, guardrail and peripheral development detections). Similarly, the vehicles 10a-10d may also be represented. In this case, a vehicle recognized by the sensors is depicted, e.g., as a short movement history. For example, the attractive boids 13 represent the vehicle 10c or the movement path thereof in that the boids 13 have been generated on the basis of the movement history of the vehicle 10c. The measurement or the established boids is/are similarly inserted into the list of the previous measurements (object list) and the position thereof corrected by means of the rules set up.

Errors in the estimation of the course of the lane, for example, may now be expediently compensated for by the observation of the path driven by other vehicles 10a-10d in that the ego-vehicle 1 or the vehicles carries/carry out its/their trajectory planning, taking account of predefined rules. For example, the following may be provided as rules: “Guardrails are parallel to lanes,” “the lanes have an at least approximately uniform width,” “the vehicles drive parallel to the lanes,” “the guardrails run on average through the measuring points,” “the guardrails do not have any kinks or forks” or the like. This automatically produces paths (“emergent behavior”) or trajectories, the course of which is parallel to the guardrails. Furthermore, the measuring values may also be weighted in a definable manner, in a similar manner to, e.g., alpha beta (αβ) filters.

An increase in the measuring accuracy is in particular achieved in that the rules of attraction allow all measurements (which each correspond to one boid) to converge on the same point in the feature space. The feature space consists of the position and direction of the ego-vehicle 1. Surprisingly, this principle may also be extended to other road users or vehicles in that, e.g., “Vehicles drive parallel to the lanes” (i.e., the same rule as for static objects, only the modeled positions of the vehicles are now changed), “vehicles do not collide with one another”, “vehicles in the same lane are aligned with one another” (“moving in queues”), “vehicles do not collide with the guardrail” and the like.

Alternatively, the space of the clothoid parameters of the trajectory may also be selected as the feature space. In this case, the individual boids would be individual measurements over time. Here, the boids could, e.g., be longitudinally fixed and only move in a lateral direction and, in terms of their curvatures, based on the rules. In a practical manner, the boids may be deleted in this case as soon as the ego-vehicle 1 has driven past them. As a result, storage and computing time may in particular be saved. Moreover, boids which represent the same object in the real world (e.g., if the boids form a compact cluster having a specified dispersion) could be combined in order to save storage and computing time.

### LIST OF REFERENCE NUMERALS

1 Ego-vehicle
2 Control device
3 Steering
4 Engine
5 Brake
6 Camera
7 Lidar sensor
8 Radar sensor
9a-9d Ultrasonic sensors
10a Vehicle
10b Vehicle
10c Vehicle
10d Vehicle
11 Boid (roadway edge road marking)
12 Boid (lane center road marking)
13 Boid (movement of the vehicle 10c)

1. A method for assistive or automated vehicle control of an ego-vehicle,
detecting, with at least one sensor, an environment and objects in the environment,
trajectory planning, by a control device comprising at least one processor circuit, on the basis of the detected objects,
defining, by the control device, boids using rules of attraction and repulsion for the objects,
carrying out, by the control device, the trajectory planning using the boids, and
carrying out, by the control device, assistive or automated control of the ego vehicle on the basis of the trajectory planning.

2. The method according to claim 1, further comprising defining, by the control device, the rules of attraction and repulsion by defining objects which are arranged within a first distance from one another and parallel as attractive boids, and objects which are arranged parallel at a greater distance than the first distance from one another as repelling boids.

3. The method according to claim 2, wherein repelling boids are defined for static objects and attractive boids are defined for moving objects.

4. The method according to claim 2, further comprising observing, by the control device, moving objects over time and creating a movement history based upon the observed moving objects, and attractive boids are defined using the movement history.

5. The method according to claim 1, further comprising saving at least one of the detected objects or the boids in an object list.

6. The method according to claim 1, further comprising defining a feature space from a position and direction of the ego-vehicle, wherein the rules of attraction for all boids are converged on a point in the feature space.

7. The method according to claim 6, wherein the feature space is defined using clothoid parameters of the trajectory planning.

8. The method according to claim 6, further comprising extending the feature space to other road users.

9. The method according to claim 1, wherein the at least one sensor comprises at least one of a camera, a lidar sensor, a radar sensor or an ultrasonic sensor.

10. A driver assistance system for an ego-vehicle for assistive or automated vehicle control of the ego-vehicle, the driver assistance system comprising:
a control device comprising at least one processor circuit, and at least one sensor for environment and object detection,
wherein the control device is configured to carry out trajectory planning on the basis of the detected objects and to carry out vehicle control of the ego-vehicle on the basis of the trajectory planning,
wherein the objects are enlisted for trajectory planning in that boids which are defined using rules of attraction and repulsion are generated for the objects, and
wherein the trajectory planning is carried out using the boids.

11. The driver assistance system according to claim 10, wherein the rules of attraction and repulsion are defined by defining objects which are arranged close to one another and parallel as attractive boids, and objects which are arranged parallel at a greater distance from one another as repelling boids.

12. The driver assistance system according to claim 10, wherein repelling boids are defined for static objects and attractive boids are defined for moving objects.

13. A computer program stored in non-transitory memory and having program code which, when executed by at least one processor circuit, causes the at least one processor circuit to perform
receiving a detected environment of an ego vehicle and detected objects in the environment,
defining boids using rules of attraction and repulsion of the detected objects,
planning a trajectory of the ego vehicle based on the defined boids, and
performing assistive or automated control of the ego vehicle based on the planned trajectory.

14. The computer program according to claim 13, wherein the rules of attraction and repulsion are defined by defining objects which are arranged close to one another and parallel as attractive boids, and objects which are arranged parallel at a greater distance from one another as repelling boids.
